(19) United States
(12) Patent Application Publication
(10) Pub. No.: US 2013/0221107 A1
(43) Pub. Date: Aug. 29, 2013

(54) METHOD FOR APPLYING ONTO A SUBSTRATE A CODE OBTAINED BY PRINTING CONDUCTIVE INKS

(71) Applicant: Paul Peter Wilkinson, Faloppio (IT)

(72) Inventor: Paul Peter Wilkinson, Faloppio (IT)

(73) Assignee: NICANTI S.R.L., Torino (TO) (IT)

(21) Appl. No.: 13/883,259

(22) PCT Filed: Nov. 4, 2011
(86) PCT No.: PCT/IB2011/054940

§ 371 Date: May 2, 2013

(30) Foreign Application Priority Data
Nov. 4, 2010 (IT) TO2010A000879

(51) Int. Cl. G06K 19/077

(52) U.S. Cl. CPC G06K 19/0776; G06K 19/077
USPC 235/488; 235/492; 156/277

(57) ABSTRACT

A method for applying a code (36) onto a substrate (39) is described where the code (36) includes a plurality of code elements obtained by printing inks having specific conductive properties, wherein the digital information associated with the code can be extracted through the use of radio frequency by subjecting the code elements to an alternating or variable electric field. The method includes the steps of: making a polymeric structure (19) including a film (11) and at least one layer (32,34) of polymeric material; printing the code (36) onto the at least one layer (32,34) of polymeric material; applying an adhesive layer (38) onto the at least one layer (32,34) of polymeric material or onto the substrate (39); applying the polymeric structure (19) onto the substrate (39); and transferring the code (36) from the polymeric structure (19) to the substrate (39).

The present invention relates to a method for generating and applying an electronic code onto a substrate.

More in particular, the present invention relates to a method for generating and applying an electronic code onto a substrate and to a polymeric structure comprising an electronic code.

Printed electronic codes are known in the art which are applied to an object so that it can be identified and/or tracked.

For example, international patent application no. WO 2009/138571 discloses a method for generating an electronic code by exploiting some electric properties of inks.

According to the above-mentioned international patent application, the electronic code is read by analyzing how a surface containing electronic codes printed in accordance with said method reacts to radio frequency.

Electrodes are used to supply an alternating (or anyway non-constant) electric signal to the electronic code and then, again by using said electrodes, the response current or voltage is measured.

Compared to other electronic code scanning systems not making use of radio frequency, the method described in the above-mentioned international patent application ensures a more reliable scan, thanks to the quality of the signal provided by analyzing the conductive properties of the ink and to the capability of obtaining said signal even when the code is read without contact, i.e. on the back side of the substrate whereto the electronic code has been applied, or through a graphic decoration layer or a protection layer protecting the code against external agents.

The use of radio frequency also ensures a better analysis of the electric properties of the inks employed for making the code, so that the electronic code can also be created by using inks having special properties, such as dielectric properties. The use of inks having special electric properties, combined with the possibility of measuring such properties by radio frequency, allows to increase the information density of a code and to make it more difficult to clone.

Electronic codes are currently obtained by printing them directly onto the final substrate.

Printing serial electronic codes, i.e. which are variable for each unit produced, and also of non-serial electronic codes, requires the use of equipment that poses many restrictions along the production process, as well as many limitations relating to the management of confidentiality, since in order to print an electronic code it is necessary to supply much confidential information to the operator to whom that task has been entrusted.

In fact, in order to print an electronic code it is necessary that the operator knows the geometric arrangement of the electronic code to be printed and the various inks to be used. Moreover, such inks might be used for cloning previously printed codes, because in order to clone an electronic code it is sufficient to know the geometric sequence to be printed and the specific inks that must be used. Cloning a code means to print a code without knowing the logic that generated it; copying a code means to print a code when the generation logic thereof is known.

Since electronic codes are mainly used in the security field, it is important to safeguard the management of confidentiality during the printing process.

In addition, the equipment for printing variable electronic codes is very expensive and slows down the printing line. Each printing line needs specific ink formulations, which further increases the printing costs and dissuades many printers from undertaking this type of activity.

It is therefore an object of the present invention to provide a method for applying an electronic code onto a substrate which ensures the confidentiality of the information contained in said electronic code during the printing process.

It is a further object of the present invention to provide a method for applying an electronic code onto a substrate which uses low-cost equipment.

These and other objects of the invention are achieved by the method for applying an electronic code onto a substrate as claimed in the appended claims, which are intended as an integral part of the present description.

In short, the present invention describes a method for applying an electronic code onto a laminar structure comprising a film and at least one layer of polymeric material, wherein said code is then transferred onto the final substrate and is finally activated.

The present invention also describes a method for making said laminar structure.

According to the present invention, the electronic code is printed in a manner such that it is protected from external agents and can be read with at least the same modalities as an unprotected code.

In particular, in accordance with the method of the present invention, a production technique is described which separates the electronic code printing process from the process in which the code is applied onto the substrate, leading to considerable advantages in terms of costs, security and material handling.

In order to apply the electronic code onto a substrate, a thermal transfer process is preferably used, of the type already in use for applying decorations and holograms.

Further features of the invention will be set out in the appended claims, which are intended as an integral part of the present description.

Said objects will become more apparent from the following detailed description of the method for applying an electronic code onto a substrate, with particular reference to the annexed drawings, wherein:

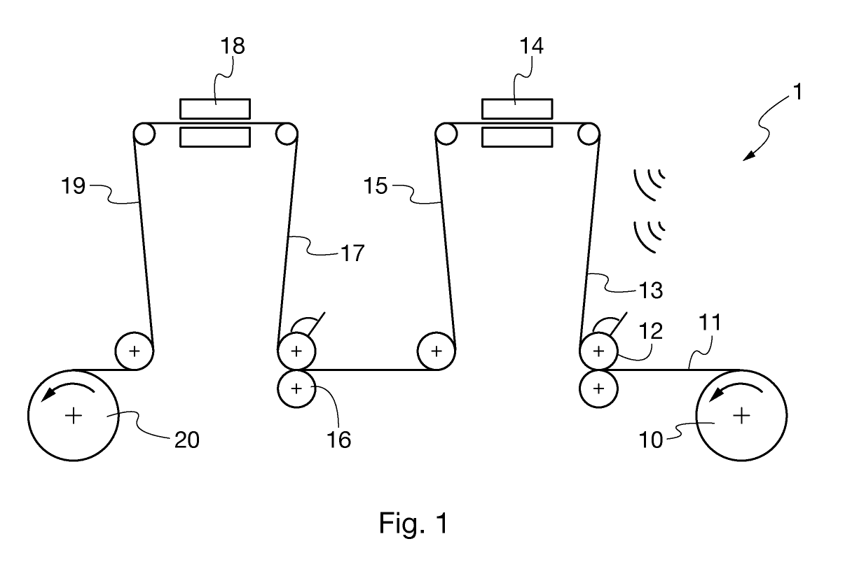

FIG. 1 diagrammatically shows a two-head smearing line for generating a laminar structure onto which at least one electronic code is applied;

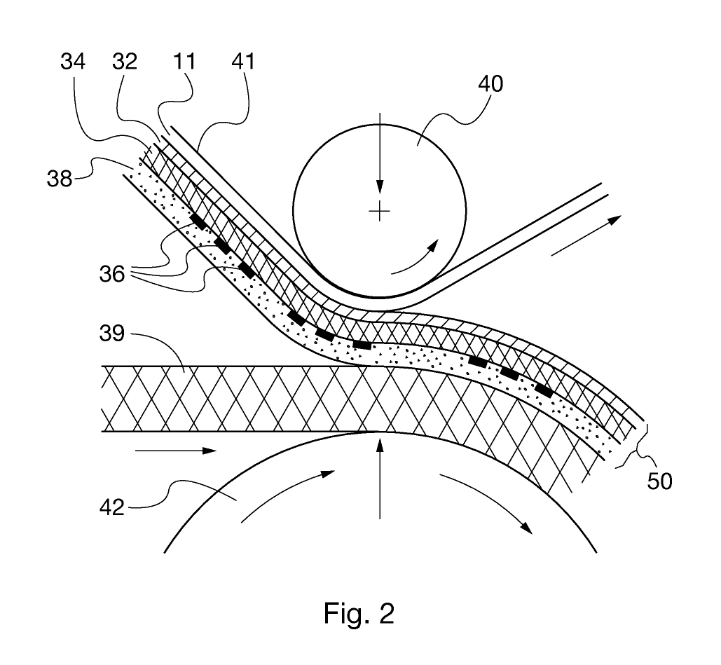

FIG. 2 diagrammatically shows the application of an electronic code onto a substrate by thermal transfer.

Referring now to FIG. 1, it diagrammatically shows a two-head smearing line 1 which comprises: film feeding means 10, in particular a calender, first smearing means 12, in particular a first smearing head with engraved cylinder and doctor blade; a first dryer 14; second smearing means 16, in particular a second smearing head with engraved cylinder and doctor blade; a second dryer 18; film winding means 20, in particular a winding machine.

The following will describe the process that must be carried out in order to obtain a polymeric structure including an electronic code.

The electronic code can be thought of as a sequence of memory cells (or code elements) printed with variably conductive inks, wherein the variability of the conductive properties of the inks in use and the geometric arrangement of the cells are directly correlated, through mathematical algorithms, to digital information.

Said digital information can only be extracted through the use of radio frequency: in fact, by subjecting the code elements to an alternating, or anyway variable, electric field, it is possible to analyze the conductive behaviour of the inks used.

Through the feeding means 10, the smearing line 1 is fed with a film 11 of plastic material or another kind of material, e.g. paper, plasticized paper or aluminium, having a thickness preferably between 8 and 50 μm, more preferably between 12 and 25 μm.

As will be described more in detail below, two layers of polymeric material, hereafter referred to as release layer 32 (see FIG. 2) and top coat layer 34, are applied onto said film 11 by means of a smearing process.

These polymeric materials are typically dissolved into solvents or emulsified into water or other low-viscosity substances.

The film 11, fed by the feeding means 10, arrives at the first smearing means 12, which smear a layer of a first polymeric material onto the film 11, so as to form the release layer 32.

Said release layer 32 is characterized in that it loses its mechanical properties when an electronic code 36 is applied onto a final substrate 39, i.e. it loses mechanical consistency above suitably defined temperatures, e.g. above 80° C. As will be clarified hereafter, the function of the release layer 32 is to facilitate the detachment of the top coat layer 34 by heating.

Subsequently, a modified film 13 on which the release layer 32 has been laid is fed to a first dryer 14, which removes the low-viscosity material (typically a solvent or solution/emulsion water) by evaporation.

Thereafter, the modified and dried film 15 is fed to second smearing means 16, which smear onto the modified and dried film 15 a layer of a second polymeric material, so as to form the top coat layer 34. Said top coat layer 34 also has the property of making the assembly made up of the film 11, the release layer 32 and the top coat layer 34 compatible with the inks used for printing.

Making the assembly compatible with printing inks means to perform at least to functions:
modifying the interface tension of the surface, so that the latter can be properly wetted by the ink used for printing an electronic code, i.e. in a manner such that the non-cured ink stays in a desired position until it has cured;
promoting the adhesion of the cured ink to the surface.

The top coat layer 34, just like the release layer 32, may also be made of a material with programmable magnetic properties or with particular reactivity to certain wavelengths, e.g. sensible ultraviolet, or ferroelectric materials.

The top coat layer 34 may also comprise decorations and/or holograms.

The top coat layer 34 may also be formulated in such a manner as to protect the electronic code 36 against external chemical agents and/or mechanical abrasion.

Subsequently, a further modified film 17, on which the top coat layer 34 has been laid, is fed to a second dryer 18, which removes the low-viscosity material of said second top coat layer 34 (typically a solvent or solution/emulsion water) by evaporation.

The selection of the materials to be smeared and of the film 11 is made mainly as a function of the processability of the end product and of the electronic, technical and aesthetic properties of the electronic code to be transferred onto the substrate 39.

One may choose materials which promote low-temperature film transfer, which materials however offer limited resistance to ageing. Other materials, which are generally more difficult to process and may require longer times and/or more pressure and/or higher temperatures, are more resistant. The materials may also have variable thickness.

It is also important to select the materials of all the layers deposited onto the film 11 in a manner such that they will not interfere, or will only interfere in a controlled manner, with the radio-frequency electromagnetic radiation: for example, it is unadvisable to use electrically conductive materials, in that they might interfere with the reading of the radio-frequency electronic code.

The materials of the film 11 and of the layers 32,34 may also be selected in a manner such that said materials intentionally interfere with the radio-frequency reading of the conductive properties of the code elements, e.g. by using materials having a known dielectric constant.

The thickness of said layers 32,34 may also be deliberately altered in a manner such that said layers interfere to a desired extent with the radio-frequency reading of the conductive properties of the code elements.

In one embodiment of the present invention, the release layer 32 and the top coat layer 34 can be obtained by using ferroelectric material. By applying an electric voltage it is possible to modify the layers' ferroelectric properties to activate or deactivate an electronic code 36, thus making it readable only after its conductivity properties have been deactivated.

In another embodiment of the present invention, the release layer 32 and the top coat layer 34 can be obtained by using a material whose electric properties change with lighting frequency and intensity: this allows to create a code that can only be read in the presence of certain light wavelengths.

Both of the above cases are based on the fact that an electronic code printed onto a conductive film is not readable, but the electronic code 38 can be made readable through a suitable radio-frequency reader by changing the respective properties of the material, and therefore its ferroelectric properties, by applying an electric voltage or by changing the photosensitivity electric properties by varying the lighting frequency and intensity.

The use of two layers of polymeric material has been described herein only by way of example. In some applications, it is conceivable to use only one layer of smeared product capable of performing all of the above-mentioned functions. In other applications, said two layers may be complemented by tie layers, decoration layers, layers of materials with special mechanical (e.g. rubbers), magnetic or ferroelectric properties, or layers with optical bar codes, or protective layers coating the electronic code.

In one variant of the invention, it is possible to smear materials whose viscosity has been reduced by heating (viscosity should be reduced in order to allow the process to operate correctly), or materials containing reactive solvents that, after smearing, are left to polymerize under ultraviolet or visible light, with or without heating. The dryers may be replaced or complemented by lamps that irradiate the film, thus originating polymerization reactions.

In a further embodiment of the invention, the layers 32,34 and additional layers are applied through techniques such as spraying, pouring or co-extrusion with the film 11: as an alternative, the layers 32,34 may also be manufactured off-line and then laminated onto the film 11.

Once the end film 19 has been obtained, in another plant or in the same line the top coat layer 34 of said end film 19 is printed, through a non-serial printing technique (e.g. offset, flexographic, serigraphic, rotogravure printing) or a serial printing technique (e.g. inkjet, toner, thermal transfer printing) with at least one electronic code 36 comprising memory cells containing at least one conductive ink, thereby obtaining a polymeric structure 50 that includes the film 11.

After printing said at least one electronic code 36 onto the top coat surface of the end film 19, and before curing or, alternatively, before drying the ink used for printing by evaporation, cooling or chemical reaction (typically a curing reaction originated by ultraviolet light), a subsequent thermally-sensitive adhesive layer 38 is applied which gets softer in a controlled way depending on its temperature, the softening temperature being such that, during the transfer process described below, the top coat layer 34 (and possibly also the release layer 32) can be detached from the film 11 and simultaneously the adhesive layer 38 can adhere to the substrate 39.

By way of example, if the softening temperature of the release layer 32 is 90° C., that of the adhesive layer may, for example, be 70° C., whereas that of the top coat layer 34 will be higher than both. In practice, the only fixed constraint is that the softening temperature of the top coat layer 34 must be higher than those of both the release layer 32 and the adhesive layer 38. The selection of the temperatures for the release layer 32 and for the adhesive layer 38 depends on many other factors, such as roller temperature, material of the substrate 39, thickness of the single layers 32,34,38, speed of the production line, and so on.

In order to reduce the softening temperature of the adhesive layer 38 and optimize its mechanical properties after the subsequent cooling step, it is possible to formulate the adhesive product with additives that polymerize at high temperature.

The application of the adhesive layer may also take place through printing. In this way, instead of smearing the adhesive onto the whole surface of the top coat layer 34, the adhesive is printed only where the sets of code elements making up the electronic code 36 are located, thus attaining significant advantages during the thermal transfer process and better aesthetic qualities of the end product.

It is also possible to create a laminated product comprising a polymeric structure 50 and a film 11, wherein the adhesive layer 38 consists of “cold” adhesive and the layer 32 consists of a material having sufficient detachment properties even at ambient or lower temperatures.

In practice, it is possible to make a laminated product that contains an electronic code which can be cold-transferred only through the effect of pressure. In this case it s necessary to carry out an additional step of applying onto the layer 38 a layer of facilitated-detachment material as a protection for the adhesive itself, which material will have to be removed before applying the code.

For practicality and productivity reasons, the length and width dimensions of the laminated product comprising the polymeric structure 50 and the film 11 are generally very big. The number of printed tracks, i.e. tracks of electronic codes 36, may even be in the order of magnitude of a few tens. Prior to application, if appropriate, the polymeric structure 50 including the film 11 is cut, by using cutting means, e.g. cutters, into strips having the same width as the pitch of the printed electronic code 36 and having a predetermined length.

With particular reference to FIG. 2, the following will describe a process for applying a film-printed electronic code obtainable according to the method of the present invention.

FIG. 2 shows a polymeric structure 50 including the film 11, on which a release layer 32, a top coat layer 34, a plurality of electronic codes 36 and an adhesive layer 38 have been applied, in this order, as previously described.

In order to apply the plurality of electronic codes 36 onto a substrate 39, e.g. made of plastic or paper-based material, the untreated surface 41 of the polymeric structure 50 is heated by using heating means 40, e.g. hot rollers or plates, to a temperature higher than the softening temperature of the adhesive 38, and then the polymeric structure 50 is pressed by the heating means 40 against the substrate 39, possibly supported by abutment means 42.

The low temperature of the substrate 39 causes an almost instantaneous curing of the adhesive layer 38, and allows the polymeric structure 50, including the release layer 32, the top coat layer 34, the electronic code 36 and the adhesive layer 38, to come off the film 11 while still adhering to the substrate 39. In some cases it is possible to heat the substrate 39 as well, thus obtaining a better penetration of the adhesive into the pores thereof.

After applying the plurality of electronic codes 36 onto the substrate 39, the film 11 is moved away, whereas the layers 32, 34 and 38 remain integral with the substrate 39. It must be pointed out that the detachment of the layer 32 may even be only partial, with no significant effects in terms of readability and appearance of the electronic code.

Alternatively, the film portion 11 may not be removed when transferring the electronic code 36, thus obtaining a more protected code having however a greater aesthetic impact: in such a case it is possible to avoid applying the release layer 32 (or at least it is unadvisable to make it by using products facilitating the separation between the film 11 and the layer 34 or the code 36), and the surface of the film 11 may be so formulated as to not require the use of a top coat layer 34.

The abutment means 42 may also act as means for moving away the polymeric structure 50, possibly deprived of the film 11.

At this point, the electronic code 36 has been applied onto the substrate 39 and is readable through radio frequency, as described in international patent application no. WO 2009/138571, but it has not been activated yet.

The activation of the electronic code 36 may take place by reading it with an accredited reader, resulting in the event being recorded into a database, or through other mass activation methods, e.g. by activating all the codes present on a coil.

The electronic code 36 may also be activated by programming a magnetic memory, if it contains programmable magnetic properties in the layers 32, 34, 38, and/or by modifying the electric properties of the layers 32, 34, 38, if they contain ferroelectric materials.

The electronic code 36 is read by radio frequency, which notoriously can cross the release layer 34 and top coat layer 32, as well as any other layers applied, including the film 11 (if not removed), so long as these are not significantly conductive.

The reading process is similar to that which can be used for reading codes printed through prior-art direct printing processes.

The features of the present invention, as well as the advantages thereof, are apparent from the above description.

A first advantage of the present invention is that it is not necessary to transfer the information about the confidentiality of the electronic code to the operator that prints the electronic code. This makes it possible to print the code in a secure place.

A second advantage of the present invention is that no special equipment is needed to print the electronic codes. In fact, it is sufficient to use thermal transfer applicators, e.g. like those already in use for transferring holograms or other decorations.

Another advantage of the present invention is that the electronic code obtainable in accordance with the method of the present invention is protected by a layer of polymeric material, and is therefore difficult to clone as well as protected against atmospheric agents and mechanical wear.

A further advantage of the present invention is that the upper layers of polymeric material can be used for introducing additional security levels into the applied code, e.g. by using luminescent properties of the material itself.

A further advantage of the present invention is that it is possible to insert into the polymeric layers materials whose properties, e.g. ferroelectric or magnetic ones, can be modified in order to activate or deactivate a code, thereby making it unnecessary to access a database to verify the activation of the code itself.

A further advantage of the method according to the present invention is that, by concentrating the variable printing into a single plant, it is possible to ensure high product quality, to earn back the investment faster, and to standardize inks.

Yet another advantage of the method according to the invention is that, since the codes are not “activated” during production, a lost or stolen coil or part thereof will not jeopardize security. In fact, if one tries to read a serial code that has not yet been activated, the latter will be simply signalled as such.

The present invention is applicable to many fields, such as printing tickets, cheques, banknotes and certificates, which may replace magnetic bands or holograms and offer the advantage of lower costs, due to the serialization of the electronic codes.

The method for applying an electronic code onto a substrate described herein by way of example may be subject to many possible variations without departing from the novelty spirit of the inventive idea; it is also clear that in the practical implementation of the invention the illustrated details may have different shapes or be replaced with other technically equivalent elements.

For example, the adhesive layer 38 may also not be a part of the polymeric structure 50. In order to cause the polymeric structure 50 to adhere to the substrate 39, during the application thereof an adhesive material is smeared directly onto the substrate 39 or onto the outermost layer of the polymeric structure 50, e.g. the top coat layer 34. In this manner, the production of the polymeric structure 50 can be standardized, and the adhesive material can be applied immediately before transferring the electronic code onto the substrate 39.

For example, the method according to the present invention can be used with inkjet printing, and also with other serial printing techniques, such as, for example, toner or thermal transfer ribbon printing (also referred to as TTF), or through other non-serial printing techniques, wherein the term “serial printing technique” refers to a technology that allows varying the printed graphics for each printed unit.

In the case of the method according to the present invention, this allows to print memories with digital contents that vary for each printed unit, and then to apply the latter onto the substrates.

It can therefore be easily understood that the present invention is not limited to a method for generating and applying an electronic code onto a substrate, but may be subject to many modifications, improvements or replacements of equivalent parts and elements without departing from the inventive idea, as clearly specified in the following claims.

1. A method for applying a code onto a substrate, said code comprising a plurality of code elements obtained by printing inks having specific conductive properties, wherein the digital information associated with the code can be extracted through the use of radio frequency by subjecting said code elements to an alternating or variable electric field, said comprising the steps of:
a) making a polymeric structure comprising a film and at least one layer of polymeric material;
b) printing said code onto said at least one layer of polymeric material;
c) applying an adhesive layer onto said at least one layer of polymeric material or onto said substrate;
d) applying said polymeric structure onto said substrate;
e) transferring said code from said polymeric structure to said substrate.

2. A method according to claim 1, wherein said step e) is carried out by means of a thermal transfer process.

3. A method according to claim 1, wherein said step e) is carried out by a pressure transfer process.

4. A method according to claim 1, wherein said adhesive layer is applied onto said at least one layer of polymeric material by printing onto said code elements.

5. A method according to claim 1, wherein in said step b) said code is printed by using a serial printing technique, in particular inkjet, toner or thermal transfer ribbon printing.

6. A method according to claim 1, wherein in said step b) said code is printed by using a non-serial printing technique, in particular offset, flexographic, serigraphic or rotogravure printing.

7. A method according to claim 1, wherein during said step e) said film is separated from said polymeric structure.

8. A method according to claim 1, wherein said at least one layer of polymeric material comprises a release layer of a first polymeric material onto which a top coat layer of a second polymeric material is applied, and said code is printed onto said top coat layer.

9. A method according to claim 8, wherein the softening temperature of said second polymeric material is higher than that of said first polymeric material.

10. A method according to claim 8, wherein said release layer and/or said top coat layer or adhesive layer have programmable magnetic properties, or feature particular reactivity to certain wavelengths or ferroelectric properties.

11. A method according to claim 10, wherein said release layer and/or said top coat layer have ferroelectric properties, and said electronic code can be activated or deactivated by applying an electric voltage.

12. A method according to claim 8, wherein said top coat layer or other layers comprise decorations and/or holograms and/or other layers of polymeric material.

13. A method according to claim 1, further comprising the step of activating said electronic code and recording such event into a database.

14. A method according to claim 1, further comprising the step of activating said electronic code and recording such event into the code itself by altering electric or magnetic properties of the code or of single code elements.

15. A polymeric structure comprising a film, characterized in that it comprises an electronic code comprising a plurality of code elements obtained by printing inks having specific conductive properties, wherein the digital information associated with the code can be extracted through the use of radio frequency by subjecting said code elements to an alternating or variable electric field, said polymeric structure being applicable onto a substrate and said code being adapted to be transferred onto said substrate.

16. A polymeric structure according to claim 15, wherein said code is printed directly onto said structure by means of inks with controlled electric conductivity.

17. A polymeric structure according to claim 15, wherein said structure comprises at least one layer of polymeric material, and wherein said code is printed onto said at least one layer of polymeric material.

18. A polymeric structure according to claim 15, comprising an adhesive layer for applying the code onto said substrate.

19. A polymeric structure according to claim 17, wherein the electric properties of the layers and/or of the film are exploited in order to alter the electric behaviour of the code elements, which can be measured through the use of radio frequency.
